(19) United States
(12) Patent Application Publication
(10) Pub. No.: US 2017/0076354 A1
(43) Pub. Date: Mar. 16, 2017

(54) Method To Carry An Item Within A Retail Shopping Facility

(71) Applicant: Wal-Mart Stores, Inc., Bentonville, AR (US)

(72) Inventors: Donald R. High, Noel, MO (US); Chandrashekar Natarajan, San Ramon, CA (US); Shuvro Chakrobartty, Bentonville, AR (US); David C. Winkle, Bella Vista, AR (US)

(21) Appl. No.: 15/263,477

(22) Filed: Sep. 13, 2016

Related U.S. Application Data
(60) Provisional application No. 62/218,426, filed on Sep. 14, 2015.

(51) Int. Cl. G06Q 30/06; G05D 1/10; B64D 47/08; B64D 1/22; B64D 1/02; G05D 1/12; B64C 39/02

(52) U.S. Cl. CPC G06Q 30/0633; G06Q 30/0639; G05D 1/12; G05D 1/101; B64C 39/024; B64D 1/22; B64D 1/02; B64D 47/08; B64C 2201/128

(57) ABSTRACT

These teachings provide for dispatching an airborne drone to an item of inventory located within a retail shopping facility, securing that item of inventory to the airborne drone, and then directing the airborne drone to carry the item of inventory to a delivery area located within the retail shopping facility. In a typical application setting the flightpath of the airborne drone will not include any traversals of open space.

### CROSS-REFERENCE TO RELATED APPLICATION

This application claims the benefit of U.S. Provisional Application No. 62/218,426, filed Sep. 14, 2015, which is incorporated herein by reference in its entirety.

### TECHNICAL FIELD

These teachings relate generally to retail shopping facilities and more particularly to the movement of items within such a facility.

### BACKGROUND

In a modern retail store environment, there is a need to improve the customer experience and/or convenience for the customer. Whether shopping in a large format (big box) store or smaller format (neighborhood) store, customers often require assistance that employees of the store can provide. Unfortunately, there may not always be enough employees available to assist customers in as timely a manner as the customer might wish.

For example, an item that a customer wishes to purchase (or already has purchased) may be located in a non-public part of the retail shopping facility such as a back storeroom. In this case a facility associate must bring that item out to the public area of the retail shopping facility to deliver that item to the customer. When there is not an associate immediately available to accomplish this task, the customer experiences delay. That experienced delay, in turn, can contribute to reduced customer satisfaction.

With increasing competition from non-traditional shopping mechanisms, such as online shopping provided by e-commerce merchants and alternative store formats, it can be important for “brick and mortar” retailers to focus on improving the overall customer experience and/or convenience.

### BRIEF DESCRIPTION OF THE DRAWINGS

The above needs are at least partially met through provision of the method to carry an item within a retail shopping facility described in the following detailed description, particularly when studied in conjunction with the drawings, wherein:

FIG. 1 comprises a flow diagram as configured in accordance with various embodiments of these teachings;

FIG. 2 comprises a top plan schematic view as configured in accordance with various embodiments of these teachings; and

FIG. 3 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these teachings provide for dispatching an airborne drone to an item of inventory located within a retail shopping facility, securing that item of inventory to the airborne drone, and then directing the airborne drone to carry the item of inventory to a delivery area located within the retail shopping facility. In a typical application setting the flightpath of the airborne drone will not include any traversals of open space.

By one approach a central computer system for the retail shopping facility conducts the foregoing dispatching and directing of the airborne drone. In these regards the central computer system can utilize a three-dimensional map of the retail shopping facility when determining a flightpath for the airborne drone. In lieu of the foregoing or in addition thereto, the central computer system can employ information from one or more on-board sensors for the airborne drone and/or one or more installed sensors for the retail shopping facility to detect obstacles in the flightpath of the airborne drone.

These teachings are highly flexible in practice and will accommodate modifications or additional functionality. For example, if desired, these teachings will accommodate landing the airborne drone at the aforementioned delivery area and detaching the item of inventory from the airborne drone. As another example, these teachings will accommodate directing the airborne drone away from the delivery area such that the airborne drone leaves the item of inventory at the delivery area.

So configured, one or more items of inventory can be relatively quickly and efficiently moved from one part of a retail shopping facility to another part of the retail shopping facility. This can include moving items of inventory between non-public and public areas of the retail shopping facility. Accordingly, at least in many cases a customer's wait for items that are not immediately available in their present location can be considerably reduced as compared to many other prior art approaches in these regards.

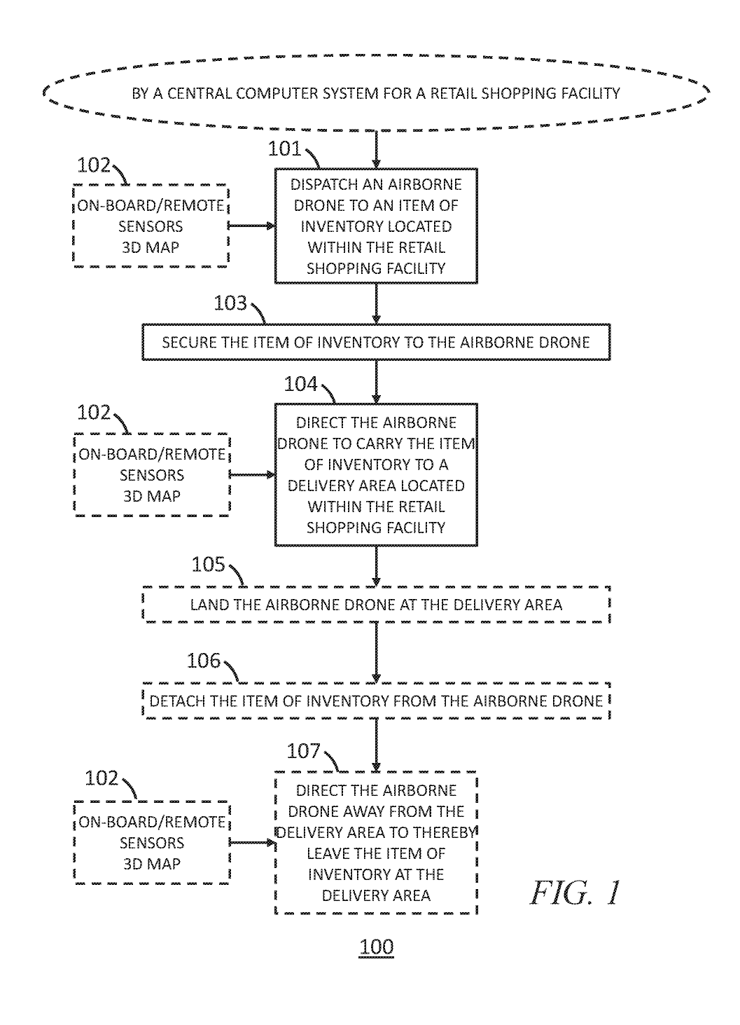

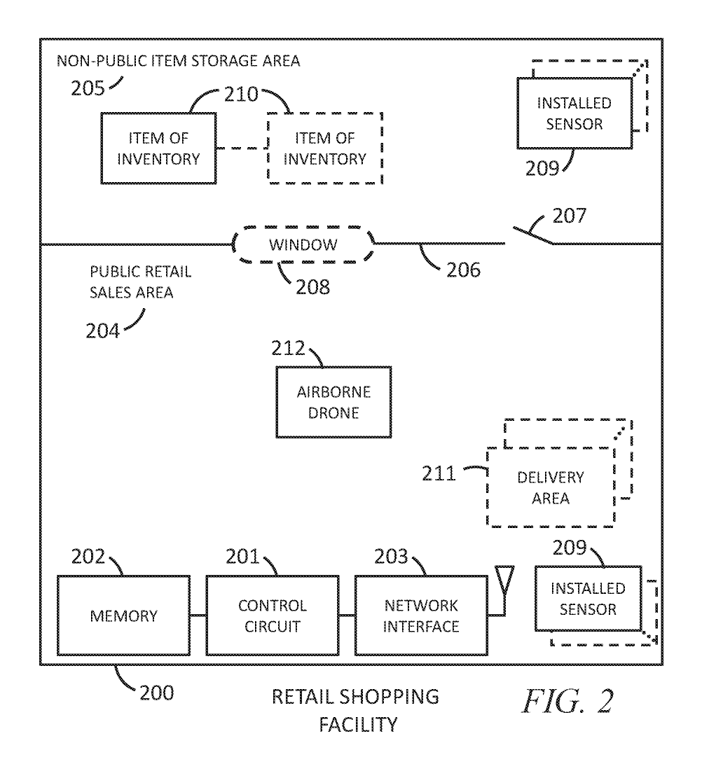

These and other benefits may become clearer upon making a thorough review and study of the following detailed description. Referring now to the drawings, and in particular to FIG. 1, an illustrative process 100 that is compatible with many of these teachings will now be presented. For the sake of an illustrative example it will be presumed here that a control circuit of choice carries out the actions, steps, and/or functions of this process 100. FIG. 2 provides an illustrative example of an application setting in these regards.

In this particular example, the retail shopping facility 200 includes such a control circuit 201. Being a “circuit,” the control circuit 201 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 201 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 201 is configured (for example, by using corresponding programming as will be well understood by those skilled in the art) to carry out one or more of the steps, actions, and/or functions described herein.

By one optional approach the control circuit 201 operably couples to a memory 202. This memory 202 may be integral to the control circuit 201 or can be physically discrete (in whole or in part) from the control circuit 201 as desired. This memory 202 can also be local with respect to the control circuit 201 (where, for example, both share a common circuit board, chassis, power supply, and/or housing) or can be partially or wholly remote with respect to the control circuit 201 (where, for example, the memory 202 is physically located in another facility, metropolitan area, or even country as compared to the control circuit 201).

In addition to information such as a three-dimensional map of the retail shopping facility 200 as discussed further herein, this memory 202 can serve, for example, to non-transitorily store the computer instructions that, when executed by the control circuit 201, cause the control circuit 201 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 201 also operably couples to a network interface 203. So configured the control circuit 201 can communicate with other elements (both within the apparatus 200 and external thereto) via the network interface 203. Network interfaces, including both wireless and non-wireless platforms, are well understood in the art and require no particular elaboration here.

For the sake of a specific illustrative example it will be presumed for the remainder of this description that the control circuit 201 comprises a central computer system.

With continued reference to FIG. 2, this retail shopping facility 200 in this example includes a public retail sales area 204 where items that are available for retail sale are displayed and typically made available for immediate purchase by a customer. The retail shopping facility 200 also includes a non-public item storage area 205 that serves as a storeroom for items that are not placed in the public retail sales area 204 for any of a variety of reasons. In this example a wall 206 separates the public retail sales area 204 from the non-public item storage area 205. This wall 206 includes a door 207 to allow facility associates to move between the two areas 204 and 205.

This wall 206 can also include one or more optional windows 208. In this example these windows are sized to accommodate an airborne drone passing therethrough while carrying an item of inventory. Accordingly, in a typical application setting this window 208 will not include glass, screens, or any other obstruction. If desired, a movable obstruction such as a rolling shutter can be installed in the window 208 to prohibit anyone or anything from passing through the window 208 unless and until the movable obstruction is moved (for example, in response to a remote control signal transmitted by an airborne drone). By one approach such a window 208 is located relatively high on such a wall 206, for example near the ceiling of the retail shopping facility 200.

In this example the retail shopping facility 200 includes one or more installed sensors 209. In this particular example there is at least one installed sensor in the public retail sales area 204 and at least one other installed sensor 209 in the non-public item storage area. These teachings will accommodate a variety of installed sensors. Examples include, but are not limited to, cameras, video cameras, sound-based proximity sensors, light-based proximity sensors, accelerometers, gyroscopes, and magnetometers, all of these devices being well known in the art. By one approach the aforementioned control circuit 201 connects to one or more of these installed sensors 209 or is otherwise configured to receive sensor information from such installed sensors 209.

For the purposes of this description it is presumed that there is one or more items of inventory 210 presently located in the non-public item storage area 205 and that a reason exists to wish to move at least one item of inventory 210 from the non-public item storage area 205 to a delivery area 211 in the public retail sales area 204. These teachings will accommodate all manner of delivery areas including but not limited to retail point-of-sale areas, customer service areas (where, for example, customers can return items for a refund), an area dedicated to picking up items delivered from the non-public item storage area 205, and so forth.

This example also illustrates the use of one or more airborne drones 212. As used herein, the expression “airborne” is not meant to refer to a current flying status of the drone but instead serves to characterize the drone 212 as being a drone that is capable of controlled flight. This is to distinguish a flying drone from a terrestrial drone. Airborne drones are a well understood though currently growing field of endeavor. As the present teachings are not overly sensitive to any particular selections in these regards, no detailed discussion regarding the general design of airborne drones is provided here.

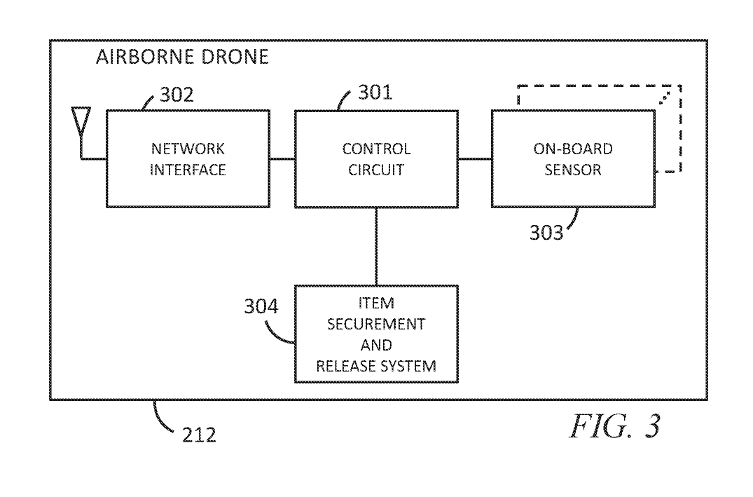

That said, and referring momentarily to FIG. 3, in this illustrative example the airborne drone 212 is presumed to itself have a control circuit 301 that can communicate with the aforementioned control circuit 201 via an on-board network interface 302. The airborne drone 212 also includes one or more on-board sensors 303 that sense one or more conditions or circumstances that the airborne drone 212 and/or the control circuit 201 can employ to develop information of interest. Examples in these regards include but are not limited to cameras, video cameras, sound-based proximity sensors, light-based proximity sensors, accelerometers, gyroscopes, magnetometers, and so forth.

With continued reference to FIGS. 1 and 2, at block 101 the central computer system (i.e., the aforementioned control circuit 201 for the retail shopping facility 200) dispatches an airborne drone 212 to an item of inventory 210 located within the retail shopping facility 200 and, in this example, more particularly in the non-public item storage area 205. When controlling the airborne drone 212 in these regards, the central computer system can make use of information from one or more of the aforementioned non-board sensors 303, one or more remote sensors such as the aforementioned installed sensors 209, and/or a three-dimensional map of the retail shopping facility 200 as may be stored in the aforementioned memory 202. The aforementioned data can be used by the central computer system when determining the flightpath for the airborne drone 212 and/or to detect one or more obstacles in the flightpath for the airborne drone 212 and to take evasive action in those regards to avoid a possible collision.

Generally speaking, the shortest distance between the departure and arrival points of the flightpath constitutes a straight line. Since the airborne drone 212 is moving higher than many of the obstacles in the retail shopping facility 200 (such as people, shelves, and various product displays), to some extent a reasonable flightpath can at least approximate that straight line. In addition to deviating from a straight line in order to avoid obstacles that are nevertheless present at the flight altitude (such as support columns, hanging promotional displays, especially high shelving, and so forth), however, other deviations from a straight line may be selected to observe other flight conditions of interest.

As one example in these regards, it may be preferable to utilize a flightpath that at least largely avoids flying over the heads of persons below. While not necessarily required in terms of safety, avoiding passing overhead made nevertheless provide an increased feeling of security for those below. Accordingly, the flightpath may be configured to largely avoid aisles between product display shelving.

As another example in these regards, it may be necessary to deviate from a straight line flightpath because the item being carried by the airborne drone 212 may hang sufficiently low beneath the airborne drone 212 to require such a deviation in order to avoid collisions between the carried item and one or more obstacles in the retail shopping facility 200.

At block 103 the item of inventory 210 is secured to the airborne drone 212. In this example, the airborne drone's item securement and release system 304 serves to effect that securement. The specific nature of this securement will vary with respect to the item securement and release system 304. By one approach, the retail shopping facility 200 can have an inventory of airborne drones 212 where many of the airborne drones 212 have different item securement and release systems 304. For example, some of these systems 304 may utilize one or more electrically-controlled hooks while others utilize magnets or nets to secure and carry items. In yet other cases the airborne drone 212 may have a cargo compartment that permits the airborne drone 212 to carry an item within its fuselage. Various securement mechanisms are known in the art. As the present teachings are not overly sensitive to any particular choices in these regards, further elaboration in these regards is not provided here.

It will also be noted that these teachings will accommodate both fully-automatic and human-assisted securement of items of inventory 210 to the airborne drone 212. When human-assisted, by one approach the central computer system can serve to provide instructions (for example, on a display screen or as a text message) to the human assistant regarding which item, and in what quantity, to secure to the airborne drone 212.

At box 104 the central computer system directs the airborne drone 212 to carry the secured item of inventory 210 to the delivery area 211 located within the retail shopping facility 200. By one approach this might comprise providing the airborne drone 212 with an identifier, coordinates, or the like as corresponds to the delivery area 211. By another approach, in lieu of the foregoing or in combination therewith, this might comprise the control circuit 201 remotely piloting, in whole or in part, the airborne drone 212 to the delivery area 211.

Once at the delivery area, by one optional approach the airborne drone 212 lands. These teachings are highly flexible in these regards and will accommodate a variety of landing zones. Examples include landing zones that are nondedicated zones of convenience as well as landing zones that are exclusively used for that purpose. By one approach the landing zone for the airborne drone 212 can be relatively open and exposed. By another approach the landing zone can be partially or fully protected from possible public observation and/or access.

Once landed, at optional block 106 the airborne drone 212 detaches the item of inventory 210 from itself. Again, these teachings will accommodate fully automatic detachment protocols as well as human-assisted protocols as desired.

Following detachment, at optional block 107 the central computer system directs the airborne drone 212 away from the delivery area 211 to thereby leave the item of inventory 210 at the delivery area 211. The waiting customer can then be provided with access to the delivered item of inventory 210. The departing airborne drone 212 can be directed to another similar task if desired, or tasked in some other regards, or directed to a staging area to await a new task and/or to recharge its onboard batteries.

As noted above, the retail shopping facility 200 may contain a window 208 through which it may be useful for the airborne drone 212 to pass (for example, when moving between the public retail sales area 204 and the non-public item storage area 205). By one approach such a window 208 is at least twice the width of the wingspan of the airborne drone 212 and at least four times as high as the airborne drone 212. Other dimensions may be appropriate in application settings having particular items to be carried and/or cargo-carrying fixtures that prompt or necessitate other dimensions.

So configured, an airborne drone 212 can be readily utilized to move items, such as products being offered for retail sale, from one place in a retail shopping facility to another place in that same facility. A considerable number of such airborne drones 212 can be simultaneously fielded and utilized to facilitate moving a considerable number of items simultaneously. Accordingly, these teachings can greatly improve the customer experience without overburdening the human associates of the facility.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
dispatching an airborne drone to an item of inventory located within a retail shopping facility;
securing the item of inventory to the airborne drone;
directing the airborne drone to carry the item of inventory to a delivery area located within the retail shopping facility.

2. The method of claim 1 wherein dispatching the airborne drone to the item of inventory and directing the airborne drone to the delivery area comprises using a central computer system for the retail shopping facility to dispatch and direct the airborne drone.

3. The method of claim 1 wherein dispatching the airborne drone to the item of inventory and directing the airborne drone to the delivery area comprises using, at least in part, on-board sensors to detect obstacles.

4. The method of claim 3 wherein dispatching the airborne drone to the item of inventory and directing the airborne drone to the delivery area further comprises using, at least in part, remote sensors to detect obstacles.

5. The method of claim 4 wherein the remote sensors include, at least in part, video cameras mounted within the retail shopping facility.

6. The method of claim 5 wherein dispatching the airborne drone to the item of inventory and directing the airborne drone to the delivery area further comprises using a central computer system to process information provided by the video cameras to thereby detect obstacles.

7. The method of claim 1 wherein dispatching the airborne drone to the item of inventory located within the retail shopping facility comprises dispatching the airborne drone to a non-public item storage area.

8. The method of claim 7 wherein the delivery area is located within a public retail sales area of the retail shopping facility.

9. The method of claim 8 wherein the delivery area comprises a retail point of sale area.

10. The method of claim 1 further comprising:
landing the airborne drone at the delivery area;
detaching the item of inventory from the airborne drone.

11. The method of claim 10 further comprising:
directing the airborne drone away from the delivery area to thereby leave the item of inventory at the delivery area.

12. The method of claim 1 wherein dispatching the airborne drone to the item of inventory and directing the airborne drone to the delivery area comprises using a three-dimensional map of the retail shopping facility when determining a flight path for the airborne drone.

13. The method of claim 12 wherein using a three-dimensional map when determining a flight path for the airborne drone comprises having a central computer system use the three-dimensional map when determining the flightpath for the airborne drone.

14. The method of claim 13 wherein determining the flightpath for the airborne drone further comprises using obstacle-detection sensor information.

15. The method of claim 14 wherein the obstacle-detection sensor information comprises information provided to the central computer system by at least one on-board sensor as corresponds to the airborne drone.

16. The method of claim 15 wherein the on-board sensor comprises at least one of:
a camera;
a video camera;
a sound-based proximity sensor;
a light-based proximity sensor;
an accelerometer;
a gyroscope;
a magnetometer.

17. The method of claim 14 wherein the obstacle-detection sensor information comprises information provided to the central computer system by at least one installed sensor as corresponds to the retail shopping facility.

18. The method of claim 17 wherein the at least one installed sensor comprises at least one of:
a camera;
a video camera;
a sound-based proximity sensor;
a light-based proximity sensor;
an accelerometer;
a gyroscope;
a magnetometer.

19. The method of claim 14 wherein the obstacle-detection sensor information comprises information provided to the central's computer system by at least one on-board sensor as corresponds to the airborne drone and by at least one installed sensor as corresponds to the retail shopping facility.

20. The method of claim 1 wherein at least one of dispatching and directing the airborne drone comprises directing the airborne drone to pass through an opening in a wall.
